(19) United States
(12) Patent Application Publication
(10) Pub. No.: US 2015/0285614 A1
(43) Pub. Date: Oct. 8, 2015

(54) TRAVEL PATH ESTIMATION APPARATUS AND TRAVEL PATH ESTIMATION PROGRAM

(71) Applicant: DENSO CORPORATION, Kariya-city (JP)

(72) Inventors: MASAYA OKADA, Chiryu-shi (JP); NAOKI KAWASAKI, Kariya-shi (JP); SYUNYA KUMANO, Gothenburg (SE); SHUNSUKE SUZUKI, Nukata-gun (JP); TETSUYA TAKAFUJI, Anjo-shi (JP)

(21) Appl. No.: 14/676,931

(22) Filed: Apr. 2, 2015

(30) Foreign Application Priority Data
Apr. 8, 2014 (JP) 2014-079260

(51) Int. Cl. G01B 11/00; G01C 21/00

(52) U.S. Cl. CPC G01B 11/00; G01C 21/00

(57) ABSTRACT

In a travel path estimation apparatus, a calculating unit calculates coordinates of edge points configuring a division line on a travel path, from an image captured by an on-board camera. An estimating unit estimates a travel path parameter of a state of the travel path and a shape of the travel path using a predetermined filter, based on the calculated coordinates of edge points. A setting unit sets a filter parameter of the predetermined filter of responsiveness of estimation of the travel path parameter. A detecting unit detects a sharp curve based on information giving advance notice of a sharp curve before the vehicle enters the sharp curve. The setting unit sets the filter parameter so that the responsiveness increases from that before detection of the sharp curve, during a period from detection of the sharp curve until the vehicle enters the sharp curve.

### CROSS-REFERENCE TO RELATED APPLICATION

This application is based on and claims the benefit of priority from Japanese Patent Application No. 2014-079260, filed Apr. 8, 2014, the disclosure of which is incorporated herein in its entirety by reference.

### BACKGROUND

1. Technical Field

The present invention relates to a travel path estimation apparatus and a travel path estimation program that estimate travel path parameters based on an image captured by an on-board camera.

2. Related Art

An apparatus has been proposed that extracts edge points of a division line on a travel path from an image of the area ahead of a vehicle that has been captured by an on-board camera, and estimates travel path parameters, such as curvature, yaw rate, and pitch angle, using a state-space filter.

In the above-described state-space filter, when the filter responsiveness of estimation of the parameters is set so as to be high, responsiveness to noise also increases. Therefore, a problem occurs in that the estimation of travel path parameters becomes unstable. Conversely, when the filter responsiveness is set so as to be low, a delay occurs in the estimation of travel path parameters when the vehicle state or road shape suddenly changes. Therefore, setting the tracking characteristics of the state-space filter based on vehicle behavior has been proposed.

For example, in JP-A-2006-285493, the dynamic characteristics of a driving matrix of the state-space filter are made variable between high characteristics and low characteristics, depending on the magnitude of the steering-angle change rate of a steering wheel, thereby making the responsiveness of the state-space filter variable.

In JP-A-2006-285493, the responsiveness of the state-space filter is changed after the steering-angle change rate of the steering wheel changes. Therefore, when the cruising environment suddenly changes, the timing at which the responsiveness of estimation is increased may be delayed.

On a sharp curve in particular, the responsiveness of the state-space filter is changed so as to be high only after the vehicle has already entered the sharp curve. Therefore, when vehicle cruising assistance is performed based on the estimated travel path parameters, turning of the steering wheel may be delayed, and the vehicle may travel so as to deviate from the travel path at the sharp curve.

### SUMMARY

It is thus desired to provide a travel path estimation apparatus that is capable of increasing responsiveness of estimation of travel path parameters at an appropriate timing, when a cruising environment suddenly changes.

A first exemplary embodiment provides a travel path estimation apparatus that includes a calculating unit, an estimating unit, a setting unit, and a detecting unit. The calculating unit calculates coordinates of edge points configuring a division line on a travel path, from an image captured by an on-board camera that captures an image of the travel path ahead of a vehicle. The estimating unit estimates a travel path parameter related to a state of the travel path in relation to the vehicle and a shape of the travel path using a predetermined filter, based on the coordinates of the edge points calculated by the calculating unit. The setting unit sets filter parameters related to responsiveness of estimation of the travel path parameters by the estimating unit. The filter parameter is a parameter of the predetermined filter. The detecting unit detects a sharp curve based on information giving advance notice of a sharp curve before the vehicle enters the sharp curve. The setting unit sets the filter parameter so that the responsiveness increases from that before detection of the sharp curve, during a period from detection of the sharp curve by the detecting unit until the vehicle enters the sharp curve.

As a result, the coordinates of edge points configuring the division line on the travel path are calculated from the image captured by the on-board camera, and the travel path parameters are estimated using the predetermined filter, based on the calculated coordinates of edge points.

Furthermore, a sharp curve is detected based on the information giving advance notice of a sharp curve before the vehicle enters the sharp curve. Then, the filter parameter related to the responsiveness of estimation of the travel path parameter is set so that the responsiveness of estimation increases from that before detection of the sharp curve, during the period from the detection of the sharp curve until the vehicle enters the sharp curve.

Therefore, the responsiveness of estimation of the travel path parameter can be increased before the vehicle enters the sharp curve. Furthermore, there is no risk of delay in turning the steering wheel on a sharp curve, even when cruising assistance is performed based on the travel path parameter. In other words, when the travel path is sharply curved, the responsiveness of estimation of the travel path parameter can be increased at an appropriate timing.

A second exemplary embodiment provides a travel path estimation apparatus that includes a calculating unit, an estimating unit, a setting unit, and a detecting unit. The calculating unit calculates coordinates of edge points configuring a division line on a travel path, from an image captured by an on-board camera that captures an image of the travel path ahead of a vehicle. The estimating unit estimates a travel path parameter related to a state of the travel path in relation to the vehicle and a shape of the travel path using a predetermined filter, based on the coordinates of edge points calculated by the calculating unit. The setting unit sets a filter parameter related to responsiveness of estimation of the travel path parameter by the estimating unit. The filter parameter is a parameter of the predetermined filter. The detecting unit detects a sudden change portion in which the state of the division line suddenly changes, based on information giving advance notice of a sudden change portion before the vehicle enters the sudden change portion. The setting unit sets the filter parameter so that the responsiveness increases from that before detection of the sudden change portion, during a period from detection of the sudden change portion by the detecting unit until the vehicle enters the sudden change portion.

As a result, the responsiveness of estimation of the travel path parameter can be increased before the vehicle enters a sudden change portion in which the state of the division line suddenly changes. Furthermore, there is no risk of delay in turning the steering wheel in the sudden change portion, even when cruising assistance is performed based on the travel path parameter. In other words, when the travel path suddenly changes, the responsiveness of estimation of the travel path parameter can be increased at an appropriate timing

### BRIEF DESCRIPTION OF THE DRAWINGS

In the accompanying drawings:

FIG. 1 is a block diagram showing a configuration of a travel path estimation apparatus according to an embodiment;

FIG. 2 is a diagram showing an overview of calculation of travel path parameters using a Kalman filter;

FIG. 3A to FIG. 3E are diagrams showing advance notice information for a sharp curve;

FIG. 4 is a flowchart showing a process for estimating travel path parameters; and

FIG. 5 is a flowchart showing a process for detecting a sharp curve.

### DESCRIPTION OF EMBODIMENTS

An embodiment in which a travel path estimation apparatus is implemented will hereinafter be described with reference to the drawings.

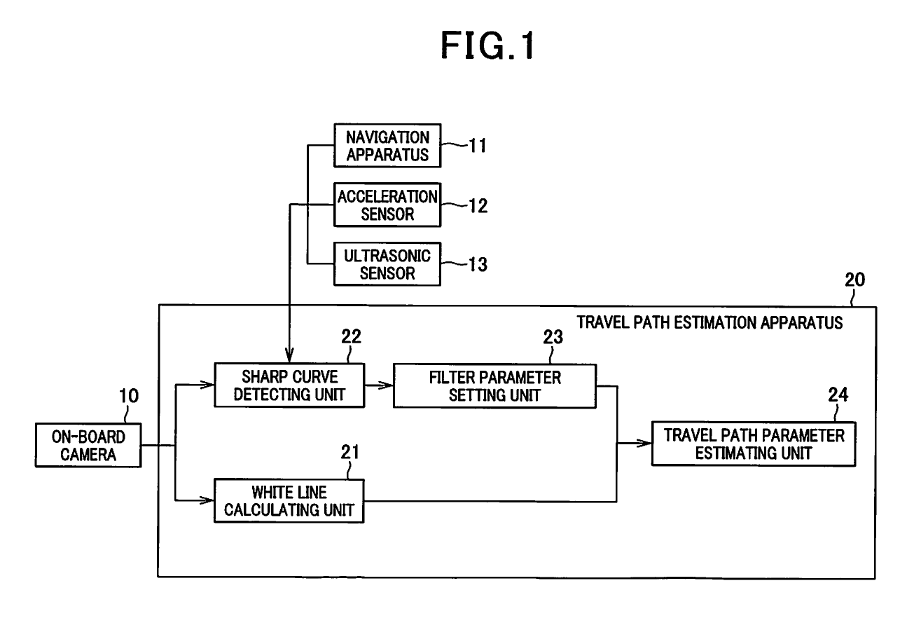

First, a configuration of a travel path estimation apparatus 20 according to the present embodiment will be described with reference to FIG. 1. The travel path estimation apparatus 20 detects a white line (division line) on a road (travel path) ahead of a vehicle from an image captured by an on-board camera 10. The travel path estimation apparatus 20 then calculates travel path parameters that are used for lane keeping control (LKA control), based on the detected white lines.

The on-board camera 10 is a charge-coupled device (CCD) camera, a complementary metal-oxide-semiconductor (CMOS) image sensor, a near-infrared camera, or the like that is mounted in the vehicle so as to capture an image of the road ahead of the vehicle. Specifically, the on-board camera 10 is attached to the front-center side of the vehicle and captures an area that spreads ahead of the vehicle over a predetermined angle range.

The travel path estimation apparatus 20 is configured as a computer that includes a central processing unit (CPU), a read-only memory (ROM), a random access memory (RAM), an input/output (I/O), and the like. The CPU runs a program (travel path estimation program) installed in a memory, such as the RAM, thereby actualizing various units (or means), such as a white line calculating unit (corresponding to a calculating unit or means) 21, a sharp curve detecting unit (corresponding to a detecting unit or means) 22, a filter parameter setting unit (corresponding to a setting unit or means) 23, and a travel path parameter estimating unit (corresponding to an estimating unit or means) 24.

The white line calculating unit 21 acquires the image captured by the on-board camera 10 and extracts edge points by applying a Sobel filter or the like to the acquired image. The white line calculating unit 21 then performs a Hough transform on the extracted edge points to detect straight lines that serve as white line candidates. The white line calculating unit 21 selects a single white line candidate each for the left and right sides, the white line candidates being the most likely to be the left and right white lines, among the detected white line candidates.

Furthermore, the white line calculating unit 21 calculates coordinates of the edge points configuring the selected white lines, on an image plane. The image-plane coordinate is a coordinate system in which the horizontal direction of an image processing screen is an m-axis and the vertical direction is an n-axis.

The travel path parameter estimating unit 24 uses a Kalman filter (specifically, an extended Kalman filter) to calculate the travel path parameters related to the road state in relation to the vehicle and the road shape, based on the coordinates of the edge points calculated by the white line calculating unit 21. The parameters related to the road state in relation to the vehicle are a lane position yc, a lane slope (yaw angle) Φ, and a pitching amount (pitch angle) β. The parameters related to the road shape are a lane curvature ρ and a lane width W1.

The lane position yc is the distance from a center line that extends in the advancing direction with the on-board camera 10 as the center, to the center of the road in the width direction, and indicates the displacement of the vehicle in the road-width direction. When the vehicle is traveling in the center of the road, the lane position yc is zero. The lane slope Φ is the slope of a tangent of virtual center lines that pass through the centers of the left and right white lines, in relation to the vehicle-advancing direction, and indicates the yaw angle of the vehicle. The pitching amount β is the pitch angle of the on-board camera 10, and indicates the pitch angle of the vehicle in relation to the road. The lane curvature ρ is the curvature of the virtual center lines that pass through the centers of the left and right white lines. The lane width W1 is the distance between the left and right white lines in the direction perpendicular to the center line of the vehicle, and indicates the width of the road.

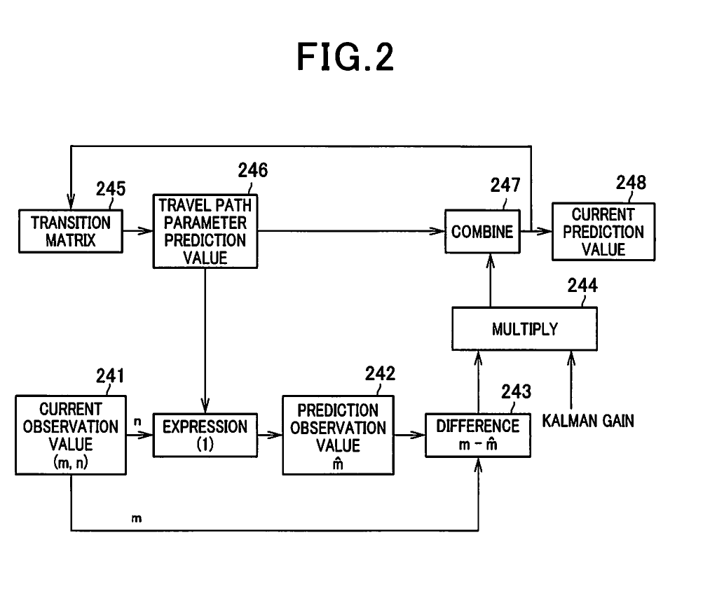

The travel path parameter estimating unit 24 uses the Kalman filter to calculate the above-described travel path parameters, using the calculated coordinates of the edge points as observation values. An overview of the travel path parameter calculation using the Kalman filter will be described with reference to FIG. 2. A previous estimate value of a travel path parameter is converted to a current prediction value 246 of the travel path parameter by a predetermined transition matrix 245.

In addition, the current prediction value 246 of the travel path parameter is converted to a prediction observation value 242 (m-coordinate value) using a current observation value 241 (n-coordinate value) and expression (1), described hereafter. Furthermore, a difference 243 that is the deviation between the observation value and the prediction value is calculated based on the current observation value 241 (m-coordinate value) and the prediction observation value 242. A weighting process 245 is performed on the calculated difference 243 using a Kalman gain. Then, a combining process 247 is performed to combine a prediction value 246 of the travel path parameter and a difference 244 that has been weighted using the Kalman gain, and a current estimate value 248 of the travel path parameter is calculated.

Next, the Kalman filter will be described. Here, a relationship between a calculated coordinate P (m,n) of a white-line edge point and the travel path parameters to be estimated (yc, Φ, ρ, W1, and β) is expressed by the following expression (1). Here, h0 represents a height of the on-board camera 10 from the road surface, and f represents a focal distance of the on-board camera 10. Expression (1) is used in an observation equation when configuring the Kalman filter.

$$m = - \frac{{f}^{2} {h}_{0}}{2 ( f β + n )} ρ + f φ + ( \frac{f β + n}{{h}_{0}} ) ( {y}_{c} \pm \frac{Wl}{2} ) \qquad ( 1 )$$

Next, a state vector xk at time k (k=0, 1, . . . N) is expressed by the following expression (2) in which T indicates a transposed matrix.

xₖ=(ρ,φ,y_{c},Wl,β)^{T} (2)

At this time, a state equation and an observation equation are expressed by the following expressions (3) and (4).

xₖ₊₁=Fₖxₖ+Gₖwₖ (3)

yₖ=hₖ(xₖ)+vₖ (4)

Here, yk is an observation vector, Fk is a transition matrix, Gk is a driving matrix, wk is a system noise, hk is an observation function, and vk is an observation noise.

The Kalman filter applied to expressions (3) and (4) is expressed as the following expressions (5) to (9) that indicate a filter formula, a Kalman gain, and an error covariance matrix formula.

### (Filter Formula)

\hat{x}_{k|k}=\hat{x}_{k|k-1}+Kₖ(yₖ−hₖ(\hat{x}_{k|-1})) (5)

\hat{x}_{k+1|k}=Fₖ\hat{x}_{k|k} (6)

### (Kalman Gain)

Kₖ=\hat{P}_{k|k-1}Hₖ^{T}(Hₖ\hat{P}_{k|k-1}Hₖ^{T}+Rₖ)⁻¹ (7)

### (Error Covariance Matrix Formula)

\hat{P}_{k|k}=\hat{P}_{k|k-1}−KₖHₖP_{k|k-1} (8)

\hat{P}_{k+1|k}=FₖP_{k|k}Fₖ^{T}+GₖQₖGₖ^{T} (9)

In expressions (5) to (9), Kk is a Kalman gain, Rk is a covariance matrix of the observation noise vk, and Qk is a covariance matrix of the system noise wk, expressed, for example, by expression (10). Qk indicates a reliability of the prediction value. In general, as Qk is larger, the system noise wk is larger and the reliability of the prediction value becomes lower. In a similar manner, in general, the reliability of the observation value becomes lower as the Rk is larger. In addition, Hk is an observation matrix expressed in expression (11).

$$\begin{matrix}{Q}_{k} = [ \begin{matrix}a & 0 & 0 & 0 & 0 \\ 0 & b & 0 & 0 & 0 \\ 0 & 0 & c & 0 & 0 \\ 0 & 0 & 0 & d & 0 \\ 0 & 0 & 0 & 0 & e\end{matrix} ] & ( 10 ) \\ {H}_{k} = {( \frac{\partial {h}_{k}}{\partial {x}_{k}} )}_{{x}_{k} = {x}_{k \vert k - 1}} & ( 11 )\end{matrix}$$

As expressed in expression (5), the travel path parameter at a predetermined time k is the sum of: the travel path parameter at the previous time k−1, or in other words, the prediction value of the predetermined time k predicted from the previously estimated travel path parameter; and a value obtained by weighting the difference between the observation value and the prediction value of the predetermined time k with the Kalman gain Kk.

Therefore, the Kalman gain Kk indicates the responsiveness of estimation of the travel path parameter. When the weight of the observation value is increased in relation to the prediction value, the responsiveness of estimation of the travel path parameter, or in other words, the trackability for changes in the state of the white lines improves. Conversely, when the weight of the prediction value is increased in relation to the observation value, the responsiveness of estimation of the travel path parameter decreases and noise resistance improves.

The value of the Kalman gain Kk changes by the covariance matrix Qk of the system noise wk and the covariance matrix Rk of the observation noise vk being changed. In other words, the covariance matrix Qk of the system noise wk and the covariance matrix Rk of the observation noise vk are filter parameters related to the responsiveness of estimation of the travel path parameters. As a result of the covariance matrix Qk of the system noise wk and the covariance matrix Rk of the observation noise vk being changed, the responsiveness of estimation of the travel path parameter can be changed.

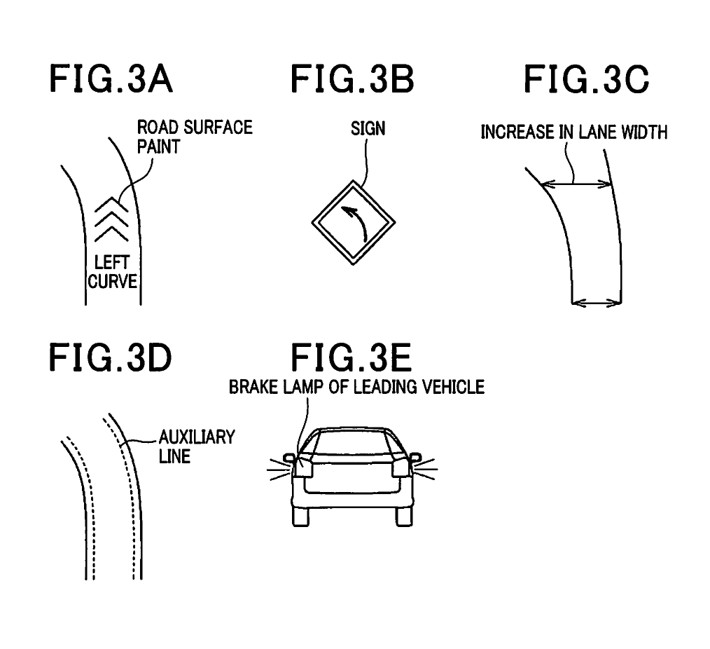

The sharp curve detecting unit 22 detects a sharp curve ahead of the vehicle based on information giving advance notice of a sharp curve before the vehicle enters the sharp curve. As shown in FIG. 3A to FIG. 3E, pieces of information that gives advance notice of a sharp curve are paint drawn on a road surface, a road sign, an increase in lane width, an auxiliary line drawn on the inner side of the white line detected by the white line calculating unit 21, illumination of the brake lamps of a leading vehicle, and the like. The sharp curve detecting unit 22 detects the information giving advance notice of a sharp curve based on the image captured by the on-board camera 10.

In addition, information giving advance notice of a sharp curve includes sharp-curve information indicated in the advancing direction in path guidance information created by a navigation apparatus 11. Furthermore, information giving advance notice of a sharp curve includes the deceleration of the own vehicle being greater than a threshold and the deceleration of the leading vehicle being greater than a threshold. Ordinarily, before a sharp curve is entered, deceleration is performed before steering is performed. Therefore, the sharp curve detecting unit 22 detects the information giving advance notice of a sharp curve based on a detection value from an acceleration sensor 12 that detects the acceleration and deceleration of the own vehicle and a detection value from an ultrasonic sensor 13 that detects the speed of the leading vehicle.

Furthermore, the sharp curve detecting unit 22 uses an expression S=α·f1+β·f2+γ·f3+ . . . to weight and integrate a plurality of pieces of detected sharp-curve advance notice information. Based on the integrated value S obtained by integrating the plurality of pieces of advance notice information, the sharp curve detecting unit 22 detects the sharp curve before the vehicle enters the sharp curve.

Here, α, β, γ, . . . each indicate the weight of a piece of advance notice information, and f1, f2, f3, . . . are each set to: i) 1 when the piece of advance notice information is detected; and ii) 0 when the piece of advance notice information is not detected. Among the pieces of advance notice information, road paint, road signs, and navigation information indicate a higher probability of a sharp curve being present in the cruising path of the vehicle, and are therefore given greater weight than other pieces of advance notice information.

The filter parameter setting unit 23 sets the filter parameters related to the responsiveness of estimation so that the responsiveness increases from that before detection of the sharp curve, during the period from the detection of the sharp curve by the sharp curve detecting unit 22 until the vehicle enters the detected sharp curve. On a sharp curve, the responsiveness for estimating the curvature of the road is required to be high so that turning of the steering wheel is not delayed. Therefore, when a sharp curve is detected, the filter parameter setting unit 23 sets the covariance matrix Qk (a, b, c, d, and e), defined by the above expression (10), of the system noise wk so that the responsiveness of estimation of travel path parameters increases, before the vehicle enters the sharp curve.

When a sharp curve is detected, the filter parameter setting unit 23 may similarly set the covariance matrix Rk of the observation noise vk, or set both the covariance matrix Qk of the system noise wk and the covariance matrix Rk of the observation noise vk. As a result, the speed at which the road curvature is estimated improves before the vehicle enters the sharp curve. Therefore, there is no risk of delay in turning the steering wheel, even when LKA control is performed based on the travel path parameters.

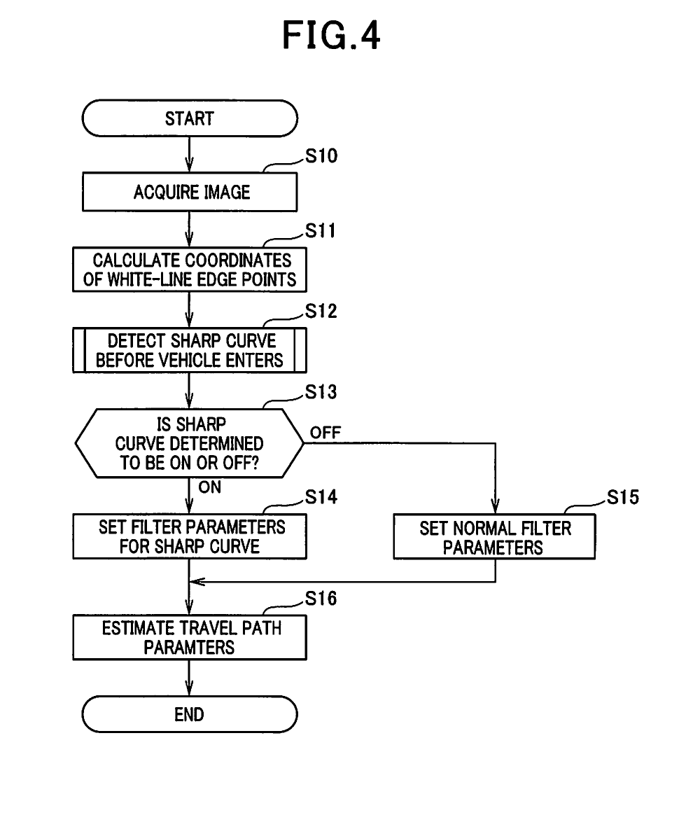

Next, a process for estimating the travel path parameters will be described with reference to the flowchart in FIG. 4. The present process is performed by the travel path estimation apparatus 20 (i.e., the white line calculating unit 21, the sharp curve detecting unit 22, the filter parameter setting unit 23, and the travel path parameter estimating unit 24) each time the on-board camera 10 captures an image.

First, the travel path estimation apparatus 20 acquires the image captured by the on-board camera (step S10). Next, the white line calculating unit 21 extracts the edge points from the image acquired at step S10 and detects the left and right white lines from the extracted edge points. The white line calculating unit 21 then calculates the coordinates of the edge points configuring the detected white lines (step S11).

Next, the sharp curve detecting unit 22 detects a sharp curve before the vehicle enters the sharp curve (step S12). The process for detecting a sharp curve will be described hereafter. In this process, a sharp curve flag is turned ON while a sharp curve is being detected. The sharp curve flag is turned OFF while a sharp curve is not being detected.

Subsequently, the filter parameter setting unit 23 determines whether the sharp curve flag is ON or OFF (step S13). In other words, the travel path estimation apparatus 20 determines whether or not a sharp curve is being detected.

When determined that the sharp curve flag is ON, or in other words, when determined that the sharp curve is being detected (ON at step S13), the filter parameter setting unit 23 sets the covariance matrix Qk of the system noise wk, which is a filter parameter of the Kalman filter, to a covariance matrix Qk for a sharp curve (step S14). The covariance matrix Qk for a sharp curve increases the weight of the observation value, compared to a normal covariance matrix Qk, and improves the responsiveness of estimation of travel path parameters.

Conversely, when determined that the sharp curve flag is OFF, or in other words, when determined that the sharp curve is not being detected (OFF at step S13), the filter parameter setting unit 23 sets the covariance matrix Qk of the system noise wk to the no mal covariance matrix Qk (step S15). The normal covariance matrix Qk increases the weight of the prediction value, compared to the covariance matrix Qk for a sharp curve, and improves stability of the estimation of travel path parameters.

Next, the travel path parameter estimating unit 24 applies the Kalman filter using the filter parameter set at step S14 or S15 to the coordinates of the edge points calculated at step S11, and estimates the travel path parameters: the lane position yc, the lane tilt Φ, the pitching amount β, the lane curvature ρ, and the lane width W1. The travel path estimation apparatus 20 then ends the present process.

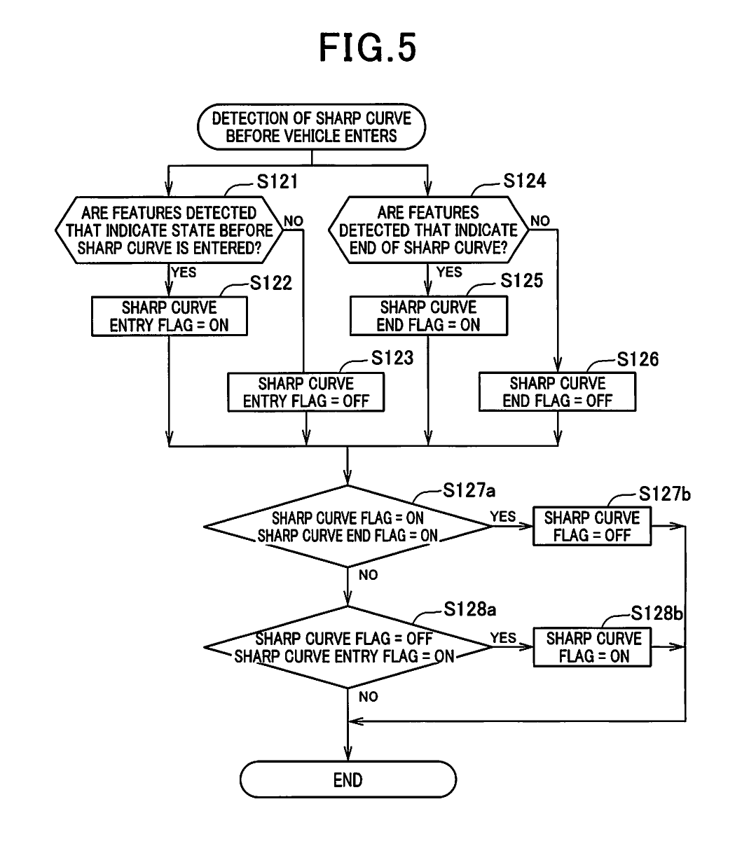

Next, the process for detecting the sharp curve before the vehicle enters the sharp curve (step S12 in FIG. 4) will be described with reference to the flowchart in FIG. 5. This process is performed by the filter parameter setting unit 23.

First, the filter parameter setting unit 23 determines whether or not features that indicate a state before a sharp curve is entered, or in other words, the advanced-notice information is detected (step S121) and determines whether or not features indicating the end of a sharp curve are detected (step S124).

The filter parameter setting unit 23 determines whether or not the features indicating a state before a sharp curve is entered are detected by determining whether or not the above-described integrated value S is a first threshold or higher. When determined that the integrated value S is the first threshold or higher, the filter parameter setting unit 23 determines that the sharp curve has been detected before the vehicle enters the sharp curve (YES at step S121) and turns ON a sharp curve entry flag (step S122). Conversely, when determined that the integrated value S is lower than the first threshold, the filter parameter setting unit 23 determines that a sharp curve has not been detected (NO at step S121) and turns OFF the sharp curve entry flag (step S123).

In addition, the filter parameter setting unit 23 determines whether or not the features indicating the end of a sharp curve are detected by determining whether or not a duration time t over which a condition, that is the integrated value S being lower than a second threshold (a value that is the first threshold or lower), is met is a determination time (such as 10 seconds) or shorter.

When determined that the integrated value S is lower than the second threshold during the determination time or longer, the filter parameter setting unit 23 determines that the end of a sharp curve has been detected (YES at step S124) and turns ON a sharp curve end flag (step S125). Conversely, when determined that the duration time t over which the condition, that is the integrated value S being lower than the second threshold, is met is shorter than the determination time, the filter parameter setting unit 23 determines that the end of a sharp curve has not been detected (NO at step S124) and turns OFF the sharp curve end flag (step S126). When the sharp curve end flag is turned ON, the sharp curve entry flag is turned OFF.

Next, when determined that the sharp curve end flag is turned ON while the sharp curve flag is turned ON (YES at step S127a), the filter parameter setting unit 23 turns OFF the sharp curve flag (step S127a). In addition, when determined that the sharp curve entry flag is turned ON while the sharp curve flag is turned OFF (NO at step S127a and YES at step S128a), the filter parameter setting unit 23 turns ON the sharp curve flag (step S128b). As a result, the sharp curve flag is turned ON during the period from the detection of the sharp curve before the vehicle enters the sharp curve until the sharp curve is no longer detected. After step S127a, step S128b, or step S128a (NO), the filter parameter setting unit 23 proceeds to the process at step S13.

According to the present embodiment described above, the following effects are achieved.

The filter parameters related to the responsiveness of estimation of travel path parameters is set so that the responsiveness increases from that before detection of the sharp curve during the period from the detection of the sharp curve until the vehicle enters the detected sharp curve. Therefore, the responsiveness of estimation of travel path parameters can be increased before the vehicle enters the sharp curve. Furthermore there is no risk of delay in turning the steering wheel, even when LKA control is performed based on the travel path parameters. In other words, when the road is sharply curved, the responsiveness of estimation of travel path parameters can be increased at an appropriate timing.

A plurality of pieces of advance notice information that are features indicating a state before a sharp curve is entered are detected before the vehicle enters a sharp curve. The plurality of pieces of detected advance notice information are each weighted and then integrated. Then, a sharp curve is detected based on the integrated plurality of pieces of advance notice information. Therefore, a sharp curve can be detected with high accuracy based on the plurality of pieces of advance notice information. Furthermore, the responsiveness of estimation of travel path parameters can be increased at an appropriate timing.

When the Kalman filter is applied, the responsiveness of estimation of travel path parameters is increased by the weight of the observation values at time k being increased in relation to the prediction value at time k, based on previously estimated travel path parameters. In addition, the responsiveness of estimation of travel path parameters decreases as a result of the weight of the observation value at time k being reduced in relation to the prediction value at time k.

Therefore, when the sharp curve is present ahead, as a result of the filter parameters related to the weights of the prediction value and the observation value being switched from the normal filter parameters to the filter parameters for a sharp curve, the responsiveness of estimation of travel path parameters can be increased.

### Other Embodiments

A sudden change portion in which the state of the white lines suddenly changes may be detected based on information giving advance notice of the sudden change portion, before the vehicle enters the sudden change portion. The filter parameters related to the responsiveness of estimation may be set so that the responsiveness is increased, during the period from the detection of the sudden change portion until the vehicle enters the detected sudden change portion. The sudden change portion includes sharp curves. The filter parameters related to the responsiveness of estimation may be set so that the responsiveness increases in stages.

As a result, the responsiveness of estimation of travel path parameters can be increased before the vehicle enters the sudden change portion in which the state of the white lines suddenly changes. Furthermore, there is no risk of delay in turning the steering wheel in the sudden change portion, even when LKA control is performed based on the travel path parameters. In other words, when the road suddenly changes, the responsiveness of estimation of the travel path parameter can be increased at an appropriate timing.

The filter used for calculation of the travel path parameters is not limited to the Kalman filter. The filter is merely required to enable the responsiveness of estimation to be adjusted by setting and, for example, may be a state-space filter such as an H-infinity (H ∞) filter.

What is claimed is:

1. A travel path estimation apparatus comprising:
a calculating unit that calculates coordinates of edge points configuring a division line on a travel path, from an image captured by an on-board camera that captures an image of the travel path ahead of a vehicle;
an estimating unit that estimates travel path parameters related to a state of the travel path in relation to the vehicle and a shape of the travel path using a predetermined filter, based on the coordinates of edge points calculated by the calculating unit;
a setting unit that sets a filter parameter related to responsiveness of estimation of the travel path parameter by the estimating unit, the filter parameter being a parameter of the predetermined filter; and
a detecting unit that detects a sharp curve based on information giving advance notice of a sharp curve before the vehicle enters the sharp curve,
the setting unit setting the filter parameter so that the responsiveness increases from that before detection of the sharp curve, during a period from detection of the sharp curve by the detecting unit until the vehicle enters the sharp curve.

2. The travel path estimation apparatus according to claim 1, wherein
the detecting unit is configured to:
detect a plurality of pieces of information giving advance notice of a sharp curve;
weight and integrate the detected plurality of pieces of information; and
detect a sharp curve before the vehicle enters the sharp curve, based on the integrated plurality of information.

3. A travel path estimation apparatus comprising:
a calculating unit that calculates coordinates of edge points configuring a division line on a travel path, from an image captured by an on-board camera that captures an image of the travel path ahead of a vehicle;
an estimating unit that estimates a travel path parameter related to a state of the travel path in relation to the vehicle and a shape of the travel path using a predetermined filter, based on the coordinates of edge points calculated by the calculating unit;
a setting unit that sets a filter parameter related to responsiveness of estimation of the travel path parameter by the estimating unit, the filter parameter being a parameter of the predetermined filter; and
a detecting unit that detects a sudden change portion in which the state of the division line suddenly changes, based on information giving advance notice of a sudden change portion before the vehicle enters the sudden change portion,
the setting unit setting the filter parameter so that the responsiveness increases from that before the detection of the sudden change portion, during a period from the detection of the sudden change portion by the detecting unit until the vehicle enters the sudden change portion.

4. The travel path estimation apparatus according to claim 1, wherein:
the predetermined filter is a Kalman filter; and
the filter parameter is a parameter related to both a weight of a prediction value at a predetermined time that is based on the travel path parameters which has been previously estimated and a weight of an observation value at the predetermined time.

5. The travel path estimation apparatus according to claim 2, wherein:
the predetermined filter is a Kalman filter; and
the filter parameter is a parameter related to both a weight of a prediction value at a predetermined time that is based on the travel path parameters which has been previously estimated; and a weight of an observation value at the predetermined time.

6. The travel path estimation apparatus according to claim 3, wherein:
the predetermined filter is a Kalman filter; and
the filter parameter is a parameter related to both a weight of a prediction value at a predetermined time that is based on the travel path parameters which has been previously estimated; and a weight of an observation value at the predetermined time.

7. A non-transitory computer-readable storage medium storing a travel path estimation program for enabling a computer to function as a travel path estimation apparatus comprising:
a calculating unit that calculates coordinates of edge points configuring a division line on a travel path, from an image captured by an on-board camera that captures an image of the travel path ahead of a vehicle;
an estimating unit that estimates a travel path parameter related to a state of the travel path in relation to the vehicle and a shape of the travel path using a predetermined filter, based on the coordinates of edge points calculated by the calculating unit;
a setting unit that sets a filter parameter related to responsiveness of estimation of the travel path parameter by the estimating unit, the filter parameter being a parameter of the predetermined filter; and
a detecting unit that detects a sharp curve based on information giving advance notice of a sharp curve before the vehicle enters the sharp curve,
the setting unit setting the filter parameter so that the responsiveness increases from that before detection of the sharp curve, during a period from detection of the sharp curve by the detecting unit until the vehicle enters the sharp curve.
